(19) United States
(12) Patent Application Publication
(10) Pub. No.: US 2018/0331964 A1
(43) Pub. Date: Nov. 15, 2018

(54) Scheduling Mechanism for Ultra-Reliable Low-Latency Communication Data Transmissions

(71) Applicant: Nokia Solutions and Networks Oy, Espoo (FI)

(72) Inventors: Guillermo Pocovi, Aalborg (DK); Klaus lngemann Pedersen, Aalborg (DK); Beatriz Soret, Aalborg (DK)

(73) Assignee: Nokia Solutions and Networks Oy

(21) Appl. No.: 15/594,824

(22) Filed: May 15, 2017

(51) Int. Cl. H04L 12/851; H04L 12/937; H04L 12/863; H04L 12/935; H04L 12/803

(52) U.S. Cl. CPC H04L 47/2483; H04L 49/254; H04L 47/6215; H04L 47/56; H04L 47/125; H04L 49/30; H04L 49/3018

(57) ABSTRACT

One or more of multiple UEs with a pending payload are assigned to individual sets of PRBs. The allocating assigns X of N total PRBs to be transmitted, X<N, wherein the allocating is performed to accommodate transmission of the corresponding payloads, given a required MCS for each of the one or more UEs, to meet an initial error rate for transmission of the payloads. One or more of the remaining N−X PRBs are reassigned to at least one user equipment that has already been allocated one or more PRBs. The MCS to be used for the at least one user equipment is adjusted given a total number of assigned PRBs per individual ones of the at least one user equipment. The adjusting lowers the initial error rate to a final error rate. The pending payloads are transmitted to the one or more UEs using the PRBs and the corresponding MCS.

### TECHNICAL FIELD

This invention relates generally to transmissions in a wireless communication system and, more specifically, relates to scheduling the transmissions in the wireless communication system.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, after the main part of the detailed description section.

In some wireless communication systems, a packet scheduler (PS) is in charge of allocating time-frequency radio resources among users (e.g., UEs) that connect to the systems. The PS therefore plays a vital role in providing Quality of Service (QoS) to the users.

The PS typically interacts closely with a LA unit. The latter is in charge of adjusting the transmission parameters (mainly the modulation and coding scheme (MCS)), in order to fulfill a certain block-error rate (BLER) constraint. Obviously, if the PS allocates more radio resources to a user, that user can use a lower MCS to transmit a certain payload size (hence the dependency between the PS and LA).

URLLC is currently a hot topic in 5G standardization activities. The idea is that future 5G networks must be able to successfully deliver a (relatively small) packet with a maximum latency of 1 (one) ms, and probability of success of up to 1×10⁻⁵ (or 99.999%). See 5G New Radio requirements in 3GPP TR 38.913.

The PS and LA unit play a vital role in satisfying the URLLC stringent requirements. The PS should prioritize URLLC transmissions over less critical traffic (e.g. mobile broadband (MBB)), whereas the LA unit should select an MCS that allows achieving a sufficiently low BLER.

### BRIEF SUMMARY

This section is intended to include examples and is not intended to be limiting.

In an exemplary embodiment, a method comprises allocating one or more of a plurality of user equipment with a pending payload to individual sets of physical resource blocks (PRBs). The allocating assigns X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads. The method includes reassigning at least one of remaining N−X PRBs to at least one user equipment that has already been allocated one or more PRBs, and adjusting the MCS to be used for the at least one user equipment given a total number of assigned PRBs per individual ones of the at least one user equipment. The adjusting lowers the initial error rate to a final error rate. The method includes transmitting the pending payloads to the one or more user equipment using the PRBs and the corresponding MCS.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform operations comprising: allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads; reassigning at least one of remaining N−X PRBs to at least one user equipment that has already been allocated one or more PRBs; adjusting the MCS to be used for the at least one user equipment given a total number of assigned PRBs per individual ones of the at least one user equipment, the adjusting lowering the initial error rate to a final error rate; and transmitting the pending payloads to the one or more user equipment using the PRBs and the corresponding MCS.

An exemplary computer program product includes a computer-readable storage medium bearing computer program code embodied therein for use with a computer. The computer program code includes: code for allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads; code for reassigning at least one of remaining N−X PRBs to at least one user equipment that has already been allocated one or more PRBs; code for adjusting the MCS to be used for the at least one user equipment given a total number of assigned PRBs per individual ones of the at least one user equipment, the adjusting lowering the initial error rate to a final error rate; and code for transmitting the pending payloads to the one or more user equipment using the PRBs and the corresponding MCS.

In a further exemplary embodiment, an apparatus comprises: means for allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads; means for reassigning at least one of remaining N−X PRBs to at least one user equipment that has already been allocated one or more PRBs; means for adjusting the MCS to be used for the at least one user equipment given a total number of assigned PRBs per individual ones of the at least one user equipment, the adjusting lowering the initial error rate to a final error rate; and means for transmitting the pending payloads to the one or more user equipment using the PRBs and the corresponding MCS.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is a logic flow diagram for scheduling for conservative ultra-reliable low-latency communication (URLLC) data transmissions, and illustrates the operation of an exemplary method or methods, a result of execution of computer program instructions embodied on a computer readable memory, functions performed by logic implemented in hardware, and/or interconnected means for performing functions in accordance with exemplary embodiments;

FIG. 3 is an example of one possible proposed resource allocation scheme;

FIG. 4 is a block diagram illustrating one possible operation of a proposed resource allocation scheme when multiplexing with other traffic, and illustrates the operation of an exemplary method or methods, a result of execution of computer program instructions embodied on a computer readable memory, functions performed by logic implemented in hardware, and/or interconnected means for performing functions in accordance with exemplary embodiments;

FIG. 5 is a graph illustrating URLLC delay performance via a cumulative distribution function (CCDF) of the latency (in URLLC delay, in ms) per received FTP3 packet for different offered loads per cell;

FIG. 6 is a graph providing a summary of URLLC 99.999%-ile (99.999 percentile) latency (in ms) under three different configurations and versus URLLC offered load (in Mbps); and

FIG. 7 is a graph providing a summary of MBB throughput performance by comparing MBB throughput (in Mbps) versus URLLC offered load (in Mbps).

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

Certain exemplary embodiments herein describe techniques for scheduling for Ultra-Reliable Low-Latency Communication (URLLC) data transmissions. As is known, URLLC is an official 3GPP abbreviation for ultra-reliable low-latency communications, defined also in 3GPP TR 38.913 as one of three main deployment scenarios (eMBB, mMTC and URLLC) for 5G new radio. URLLC is therefore a requirement that 5G networks shall fulfill. In this text, we use the term ‘URLLC UE’ for a UE that receives URLLC type of traffic. That is, payloads that shall be received with low latency and ultra-reliability. Similarly, the term ‘eMBB UE’ (or ‘MBB UE’) is a terminal that receives eMBB-type (or MBB-type) of traffic. The base station is aware of the requirements of each UE, and should serve them accordingly. Although the term ‘URLLC UE’ is primarily used herein, these techniques also apply to UEs with low-latency and ultra-reliable communication requirements and corresponding traffic.

Keeping these definitions in mind, the techniques described herein may in particular relate to an integrated multi-user packet scheduling (PS) and link adaptation (LA) solution with superior support of ultra-reliable low-latency communications in radio systems. As an example, a packet scheduling framework is disclosed that aims to provide low BLER of URLLC transmissions, while still serving many URLCC UEs in coherence with their QoS requirements, and without unnecessarily harming the potential eMBB users that could co-exist on the same cell. The proposed techniques are described on a general level, where they could be made applicable for evolved versions of 3GPP LTE and/or the upcoming 5G New Radio (NR). Additional description of these techniques is presented after a system into which the exemplary embodiments may be used is described.

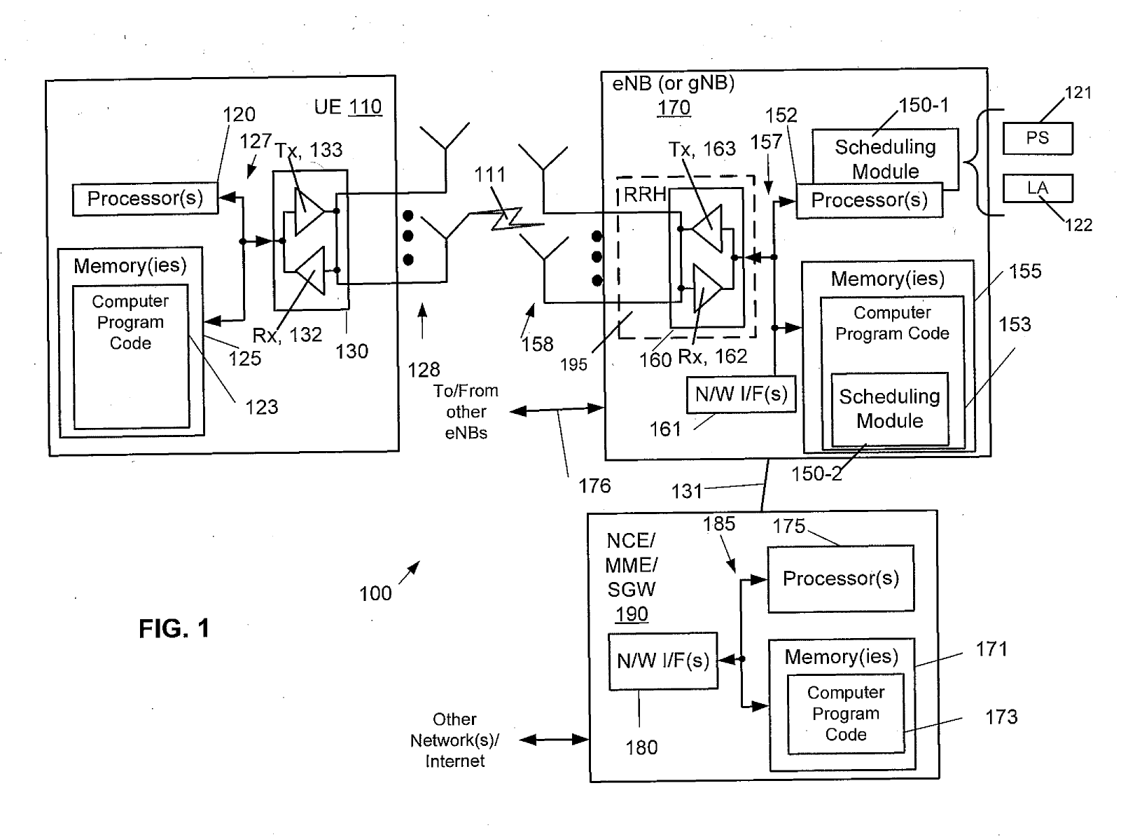

Turning to FIG. 1, this figure shows a block diagram of one possible and non-limiting exemplary system in which the exemplary embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The one or more memories 125 and the computer program code 123 may be configured to, with the one or more processors 120, cause the user equipment 110 to perform one or more of the operations as described herein. The UE 110 communicates with eNB 170 via a wireless link 111.

The eNB (evolved NodeB) 170 is a base station (e.g., for LTE, long term evolution) that provides access by wireless devices such as the UE 110 to the wireless network 100. For 5G, the eNB 170 may be a gNB, which is a base station for 5G/NR. The examples herein use the term “eNB”, but a gNB is equally applicable. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a scheduling module 150, comprising one of or both parts 150-1 and/or 150-2, which may be implemented in a number of ways. The scheduling module 150 may be implemented in hardware as scheduling module 150-1, such as being implemented as part of the one or more processors 152. The scheduling module 150-1 may be implemented also as an integrated circuit or through other hardware such as a programmable gate array. In another example, the scheduling module 150 may be implemented as scheduling module 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The scheduling module 150 typically comprises a packet scheduler (PS) 121 and a link adaptation (LA) unit 122, and the algorithms for these are modified in certain exemplary embodiments provided below.

The one or more network interfaces 161 communicate over a network such as via the links 176 and 131. Two or more eNBs 170 communicate using, e.g., link 176. The link 176 may be wired or wireless or both and may implement, e.g., an X2 interface. The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

It is noted that description herein may indicate that “cells” perform functions, but it should be clear that the eNB that forms the cell will perform the functions. The cell makes up part of an eNB. That is, there can be multiple cells per eNB. For instance, there could be three cells for a single eNB carrier frequency and associated bandwidth, each cell covering one-third of a 360 degree area (called a “sector”) so that the single eNB's coverage area covers an approximate oval or circle. Furthermore, each cell can correspond to a single carrier and an eNB may use multiple carriers. So if there are three 120 degree cells per carrier and two carriers, then the eNB has a total of 6 cells.

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, eNB 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the exemplary embodiments of this invention, the exemplary embodiments will now be described with greater specificity.

As indicated above, the PS 121 and LA unit 122 play a vital role in satisfying the stringent requirements for URLLC. The PS 121 should prioritize URLLC transmissions over less critical traffic (e.g., mobile broadband (MBB) or evolved MBB, eMBB), whereas the LA unit 122 should select an MCS that allows achieving a sufficiently low BLER.

By decreasing the BLER of the URLLC data transmissions, one can reduce the occurrence of retransmissions, which improves latency. Lower BLER is typically achieved by applying a more conservative MCS. Therefore, the lower the BLER target, the more radio resources are required to transmit a fixed amount of data. In a dynamic multi-user system, where multiple URLLC data transmissions may occur at the same time, it is therefore not trivial to determine how conservatively/aggressively (e.g., on how many PRBs) the URLLC users should be scheduled, as performing an allocation with extremely low BLER could result in a lack of radio resources to other URLLC data transmissions.

In examples herein, we provide mechanisms that overcome these issues. In an exemplary embodiment, we divide the scheduling framework into two steps: a first step where radio resources are allocated to URLLC UEs 110 with a relatively high degree of aggressiveness; and a second step where the allocation size of each UE could be increased (e.g., resulting in a more conservative transmission), depending on the available resources. This allows for dynamic adjustment of the system (on a TTI basis), e.g., depending on the current system load or load per cell, among other parameters.

Scheduling and link adaption for cellular systems such as WiMAX, HSPA, and LTE have been exhaustively studied. As a few examples, scheduling algorithms that aim at fulfilling users' QoS requirements (including latency targets) include scheduler solutions presented in the following:

1) G. Barriac, J. Holtzman, “Introducing Delay Sensitivity into the Proportional Fair algorithm for CDMA Downlink Scheduling”, IEEE Proc. ISSSTA, pp. 652-656, September 2002;

2) M. Andrews, K. Kumaran, K. Ramanan, A. Stolyar, and P. Whiting, “Providing Quality of Service over a Shared Wireless Link”, IEEE Communications Magazine, vol. 39, no. 2, pp. 150-154, February 2001; and

3) T. E. Kolding, “QoS-Aware Proportional Fair Packet Scheduling with Required Activity Detection”, IEEE Proc. VTC, September 2006; and

4) G. Song, Y. Li, “Utility-Based Resource Allocation and Scheduling in OFDM-Based Wireless Broadband Networks”, IEEE Communications Magazine, pp. 127-134, December 2005.

It is clear from those studies that users with highest priority should be favored when allocating radio resources, e.g., either by using a hard priority or soft priority type of solution. Until recently, the known scheduler studies have focused on deriving algorithms that are capable of performing resource allocations to fulfill user diverse user QoS requirements such as users with different average minimum data rate targets, and users with different average head-of-line latency targets. However, with the goal of introducing URLLC for the 5G NR, one additional dimension to the scheduling/link adaptation problems emerges, as each individual URLLC transmission should be timely scheduled to fulfill the strict latency requirement with the ultra-reliable constraints.

In this context, the patent application WO 2007018906, “Wireless communication method and apparatus for detecting and scheduling urgent data”, Interdigital, 2007, describes one candidate procedure where a base station prioritizes critical data, which should be transmitted, e.g., with a more conservative MCS. However, how aggressively or conservative these users should be scheduled (e.g., on how many PRBs) is still an open problem for a dynamic multi-service system, where multiple pending URLLC data transmission may occur at the same time. Further, one objective is naturally to be able to efficiently serve the URLLC users, while limiting the penalty experienced by the mobile broadband (MBB) users, and this is not currently addressed.

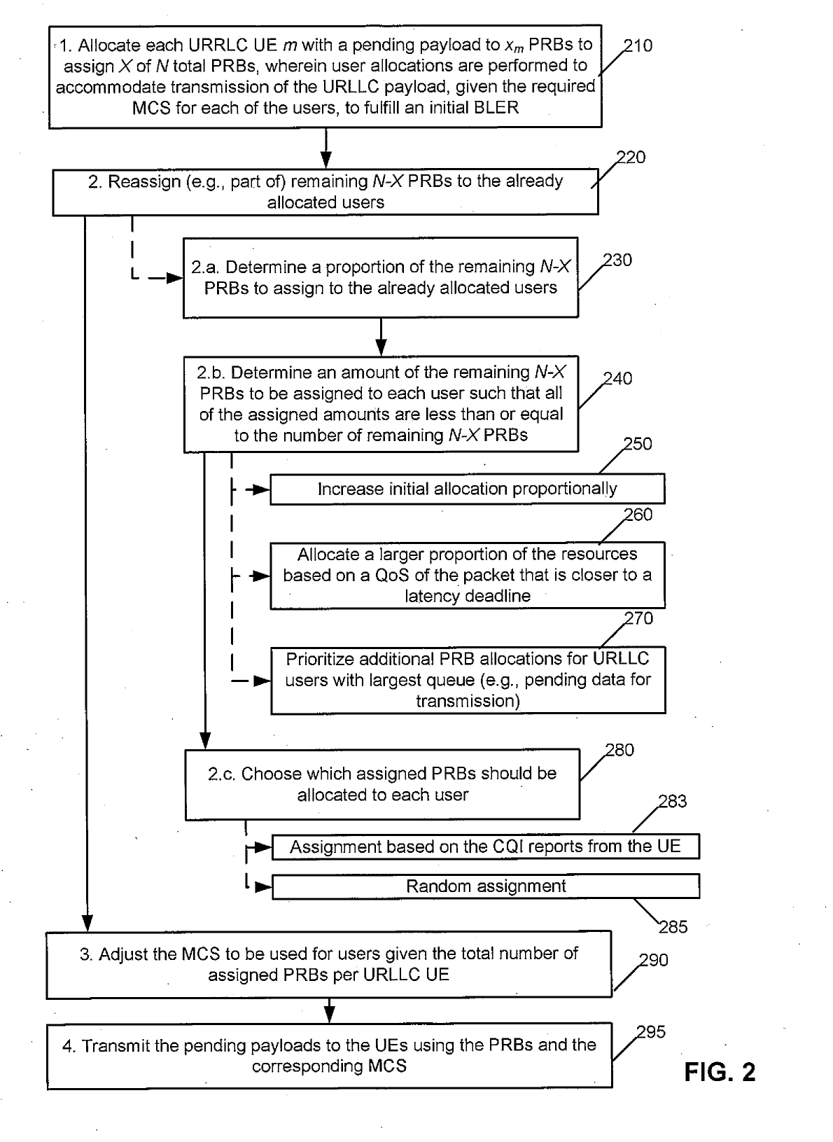

In a cellular radio system where, on each Transmission Time Interval (TTI), a cell (e.g., eNodeB or gNodeB in LTE/5G terminology) can allocate up to N physical resource blocks (PRBs) to a set of M URLLC UEs, one exemplary embodiment comprises steps 1 to 4 as summarized below. These steps are also described in reference to FIG. 2, which is a logic flow diagram for scheduling for URLLC data transmissions. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the scheduling module 150 may include multiples ones of the blocks in FIG. 2, where each included block is an interconnected means for performing the function in the block. The blocks in FIG. 2 are assumed to be performed by a base station such as eNB 170, e.g., under control of the scheduling module 150 (and its corresponding PS 121 and LA unit 122) at least in part. It is also noted that the terms “user” and “user equipment” are interchangeable in FIG. 2.

In step 1 (see also block 210 of FIG. 2), each URLLC UE m with a pending payload is initially assigned xₘ PRBs (xₘ≥0 and Σ_{i∈M} xᵢ≤N). The user allocation xₘ is done to accommodate transmission of each URLLC payload, given the required MCS for each of the users to fulfill an initial BLER of, e.g., 1% (one percent). The MCS selection is based on the channel quality experienced by the UEs. The channel quality is typically indicated in the periodically-reported CQI report (although other estimates of channel quality may be used). Therefore, the CQI is typically known at the moment of transmission.

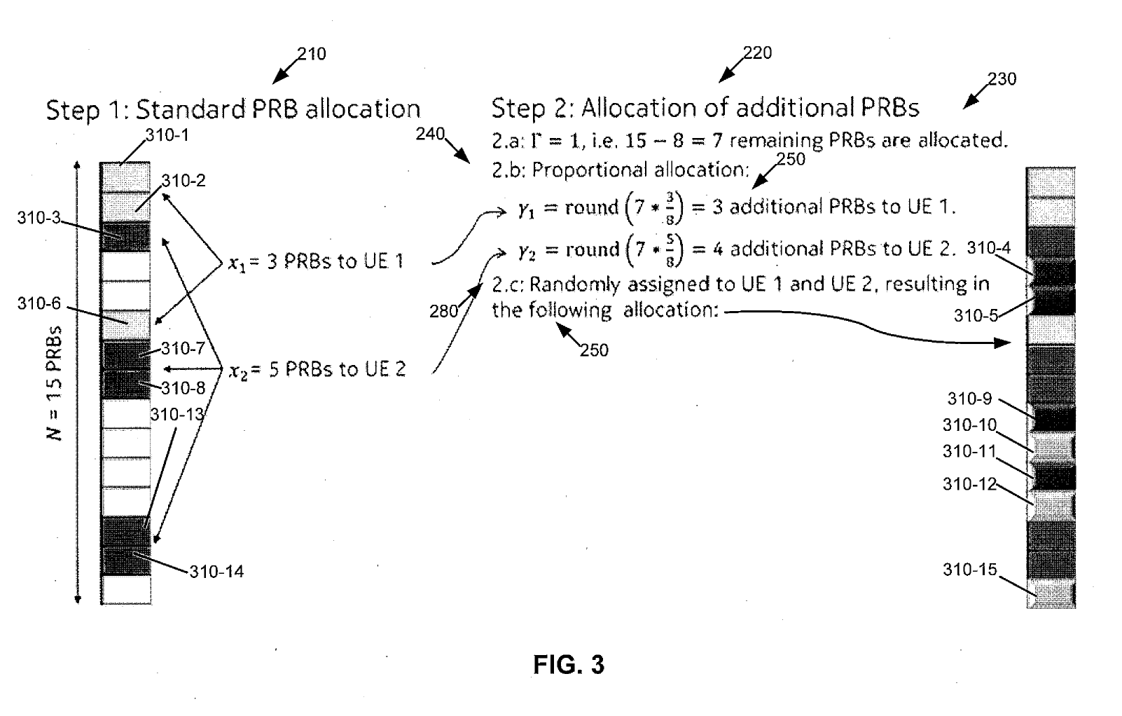

FIG. 3 depicts an example with M=2 UEs and N=15 PRBs. The operation in block 210 is illustrated by “Step 1: Standard PRB allocation”. Both UE 1 and UE 2 need to transmit a small packet with very high reliability and low latency. UE 2 receives a larger allocation since this UE experiences worse signal quality. In particular, three PRBs 310-1, 310-2, and 310-6 of the 15 PRBs 310 are allocated to UE 1 in step 1. Meanwhile, five PRBs 310-3, 310-7, 310-8, 310-13, and 310-14 of the 15 PRBs 310 are allocated to UE 2 in step 1.

In step 2 (see also block 220 of FIG. 2), once the initial X=Σ_{i∈M} xᵢ PRBs have been allocated, the base station reassigns (e.g., part of) the remaining N−X PRBs to the already allocated users. Assuming that the user buffered data are small (e.g., typically not exceeding one URLLC packet), the additional resources will allow transmitting the same amount of data with a more conservative MCS (e.g., providing an even further reduced BLER). This is performed according to the following procedure in an exemplary embodiment, as illustrated by blocks 230, 240, and 280.

In a step 2.a (see block 230 of FIG. 2), the proportion Γ of the N−X remaining PRBs are determined, which should be assigned to the already allocated users. The highest reliability improvement is obtained when all the remaining PRBs are allocated (Γ=1), but schemes with 1>Γ>0 could be relevant for other KPIs, e.g., spectral efficiency or energy consumption.

In a step 2.b (see block 240 of FIG. 2), the amount of PRBs to be allocated to user m, γₘ, is determined such that Σ_{i∈M} γᵢ≤Γ*(N−X). One possible embodiment is to select γₘ such that the initial allocation of PRBs for each user (performed in step 1, block 210) is increased proportionally. See block 250. A ‘generic formulation’ of block 250 (proportional allocation) could be:

$${γ}_{u} = \frac{Γ * ( N - X )}{X} * {x}_{u} .$$

This matches the equations in FIG. 3, assuming Γ=1, N=15, X=8. Another possible strategy is to take into account QoS of the packet (in a pending payload), e.g., by allocating a larger proportion of the resources (e.g., the remaining PRBs) to the data, which is closer to the latency deadline. See block 260. Additionally, this may include prioritizing additional PRB allocations for URLLC users with largest queue, e.g., pending data for transmission. See block 270.

In a step 2.c, once the amount of PRBs to be allocated to each user has been determined, the next step comprises choosing which PRBs should be allocated to each user (see block 280 of FIG. 2). This procedure could be made following traditional procedures as known from, e.g., LTE, such as being based on the CQI reports from the UE (block 283), or random spread allocation in order to gain from frequency diversity (block 285). The channel quality used is channel quality information in general and is not limited strictly to CQI. In fact, this knowledge could be obtained in multiple ways other than just reports from the UE. For example, in TDD systems, the channel is symmetric in both uplink and downlink directions so no explicit CQI reports are needed from the UE.

In step 3 (see also block 290), given the total number of assigned PRBs per URLLC UE (i.e., the results of steps 1 and 2 and corresponding blocks 210 and 220, respectively), the used MCS for those users is adjusted. That means if more PRBs are assigned a URLLC user as part of step 2 (block 220), the MCS is lowered, resulting in a lower experienced BLER as compared to the initial BLER of, e.g., 1% (one percent). This results in increased reliability.

For step 4 (see block 295), the pending payloads are transmitted to the UEs using the allocated PRBs and the corresponding MCS. Where Γ=1, all PRBs in a transmission would be allocated to URLLC UEs and their corresponding payloads. For cases where 0<Γ<1, not all the N PRBs will be scheduled to URLLC UEs (and thus less than all N PRBs would be transmitted, assuming no lower priority data are allocated to the PRBs not assigned to URLLC UEs).

Step 2 (block 220) is also depicted in FIG. 3, under the heading of “Step 2: Allocation of additional PRBs”. The example assumes P=1 in step 2a (block 230), proportional allocation in step 2b (blocks 240 and 250), and random assignment in step 2c (blocks 280 and 285). The larger allocation given to each user allows transmitting the URLLC packet with lower error probability.

As can be seen, the initial three PRBs to UE 1 are increased as follows:

$${γ}_{1} = round ( 7 * \frac{3}{8} ) = 3$$

additional PRBs to UE 1. The initial allocation of PRBs 310-1, 310-2, and 310-6 (see the left side of FIG. 3) is expanded to include PRBs 310-10, 310-12, and 310-15 (see right side of FIG. 3), for a total of six PRBs 310 allocated to UE 1.

The initial five PRBs to UE 2 are increased as follows:

$${γ}_{2} = round ( 7 * \frac{5}{8} ) = 4$$

additional PRBs to UE 2. The initial allocation of PRBs 310-3, 310-7, 310-8, 310-13, and 310-14 (see the left side of FIG. 3) is expanded to include PRBs 310-4, 310-4, 310-9, and 310-11 (see right side of FIG. 3), for a total of nine PRBs 310 allocated to UE 2.

The proportional allocation in block 240 and 250 uses the round(•) function with the proportions of ⅜ for UE 1 and ⅝ for UE 2, and each proportion is each UE's portion of the eight allocated PRBs 310. The round(•) function is described as follows. In general, we consider that the base station assigns resources on a PRB resolution. Therefore, N, X, xᵢ,γₘ must be integer numbers. In the calculations, we therefore need to apply some rounding such that we do not allocate a fraction of PRBs to users. In most of the cases, rounding to the nearest integer fits fine (as in the example in FIG. 3).

However, in some cases, the rounding should be made more smartly. For example, assuming we have N=15 PRBs in total, Γ=1, x₁=6 and x₂=6 (X=6+6=12):

$${γ}_{1} = {γ}_{2} = 3 * \frac{6}{12} = 1.5 .$$

If we apply traditional rounding, γ₁ and γ₂ would be equal to 2, which is not possible because it would require scheduling 16 PRBs rather than the 15 PRBs available. In such cases, one user should get only one PRB and the other should get two PRBs (i.e., one γ is rounded up and the other is rounded down). This could be randomly decided or based on other metrics.

In blocks 280 and 285, the random assignment randomly assigns the seven newly allocated PRBs to the seven unassigned PRBs: 310-4, 310-5, 310-9 through 310-12 and 310-15.

Step 2 (block 220), including its procedures 2.a, 2.b, 2.c, and embodiment variants, represents a main step of the various embodiments. This step presents a non-trivial solution that efficiently satisfies the stringent reliability requirements of URLLC users, to which no solutions are currently known. As described below, the proposed embodiments also become relevant in cases where URLLC traffic is multiplexed with other types of traffic, e.g., MBB. In such scenarios, the parameter provides a simple and effective method to determine how the radio resources should be distributed between URLLC and MBB.

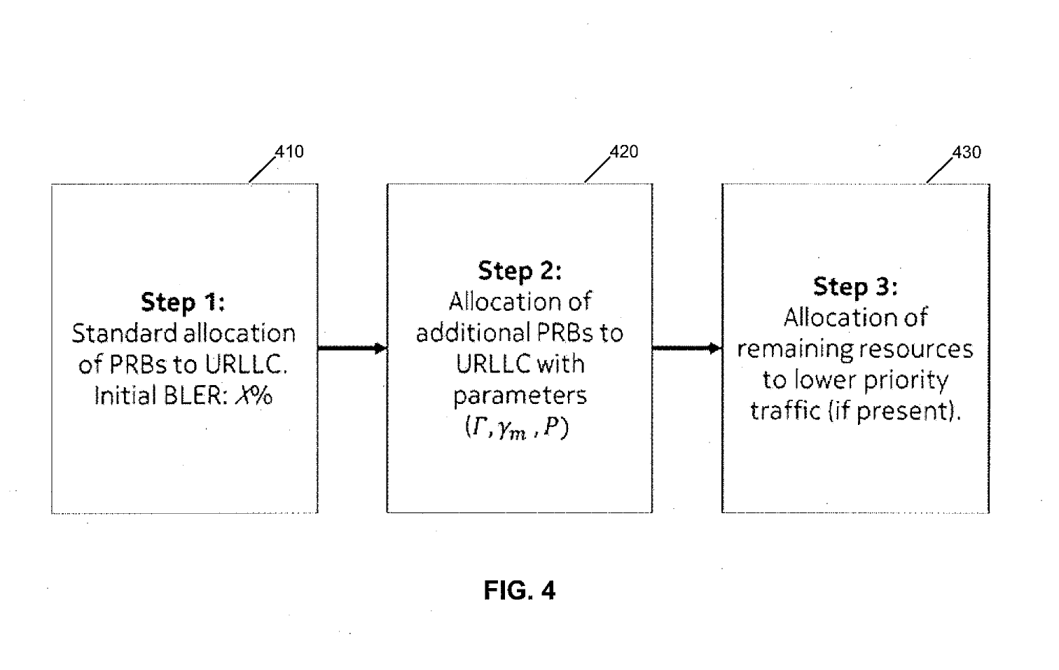

The exemplary embodiments may use modifications in the base station packet scheduler algorithms (e.g., in PS 121) and link adaptation algorithms (e.g., in LA unit 122). An example of an operation of a proposed resource allocation scheme when multiplexing with other traffic is presented in FIG. 4. This example concerns the following: (1) UEs determined to be higher priority (e.g., URLCC UEs) and having corresponding higher-priority pending payloads; and (2) one or more additional user equipment determined to be lower priority (e.g., MBB or eMBB) and having corresponding lower-priority pending payloads. In the first step in block 410, the base station allocates PRBs to a set of URLLC UEs in order to satisfy a relatively modest initial BLER constraint, e.g., 1-5% (one to five percent). Next, in step 2 and block 420, if additional resources are available, the proportion Γ of the available resources is further distributed among the URLLC UEs, such that each UE m gets an additional γₘ PRBs selected with a procedure P. A procedure P refers to the criterion used for assigning PRBs to users (i.e. step 2.c). For cases where URLLC traffic is multiplexed with other types of (lower-priority) traffic, e.g., MBB, the remaining PRBs (if any) can be allocated to other types of traffic. This occurs in step 3, block 430. In such case, the highest URLLC reliability improvement is obtained when the base station is configured to use Γ=1, at the expense of the largest MBB throughput degradation.

An exemplary embodiment includes an apparatus with means for performing the functions in the blocks in FIGS. 2 and 4. That is, each of the blocks in these figures (and also other description associated with the blocks) could be implemented as a means for performing the function described in the block (or in the associated description).

The proposed techniques therefore solve the outlined problem of performing conservative URLLC transmissions (i.e., with low BLER), while limiting the impact on other URLLC and MBB UEs that could be scheduled in the same TTI. This may be achieved by, e.g., dividing the URLLC scheduling procedure into two steps, such that the grade of conservativeness is adjusted according to the instantaneous system load: at low load, when only few URLLC UEs are active, very conservative transmissions are performed. As the load increases, it converges to known scheduling approaches, since a large amount of PRBs are already allocated in step 1 (e.g., of FIG. 2 or 4). Another advantage, perhaps even more relevant, is to employ the parameter as a simple and effective way to determine how the radio resources should be distributed between URLLC and MBB and address the tradeoffs between latency, reliability, and spectral efficiency.

To quantify the relevance of the exemplary embodiments, we have performed system level simulations with and without a version of a proposed technique. The network topology and the channel model follow the guidelines in 3GPP, TR 36.872 “Small Cell Enhancements for E-UTRA and E-UTRAN—Physical Layer Aspects,” v. 12.0.0, September 2013. The network is composed of seven three-sector sites (21 cells) located with 500 meter inter-site distance. We use the same physical layer numerology as in LTE (15 kHz sub-carrier spacing, PRB size of 12 subcarriers) but assume a TTI size of only two OFDM symbols (0.143 ms). Note that this numerology is also valid for the 5G New Radio—see details in 3GPP TR 38.802. The system-level simulator includes detailed modeling of major radio resource management functionalities such as packet scheduling, hybrid automatic repeat request (HARQ), link adaptation, 2×2 closed loop single-user MIMO with dynamic precoding. Proportional fair (PF) scheduling is applied independently at each cell, and the carrier bandwidth is 10 MHz.

In the first set of results, a set of 210 URLLC UEs 110 are uniformly distributed across the network (an average of 10 UEs per cell). Unidirectional downlink traffic following the so-called FTP Model 3 is applied. This consists of 200 Bytes packets that are generated for each URLLC UE in the downlink direction following a Poisson arrival process.

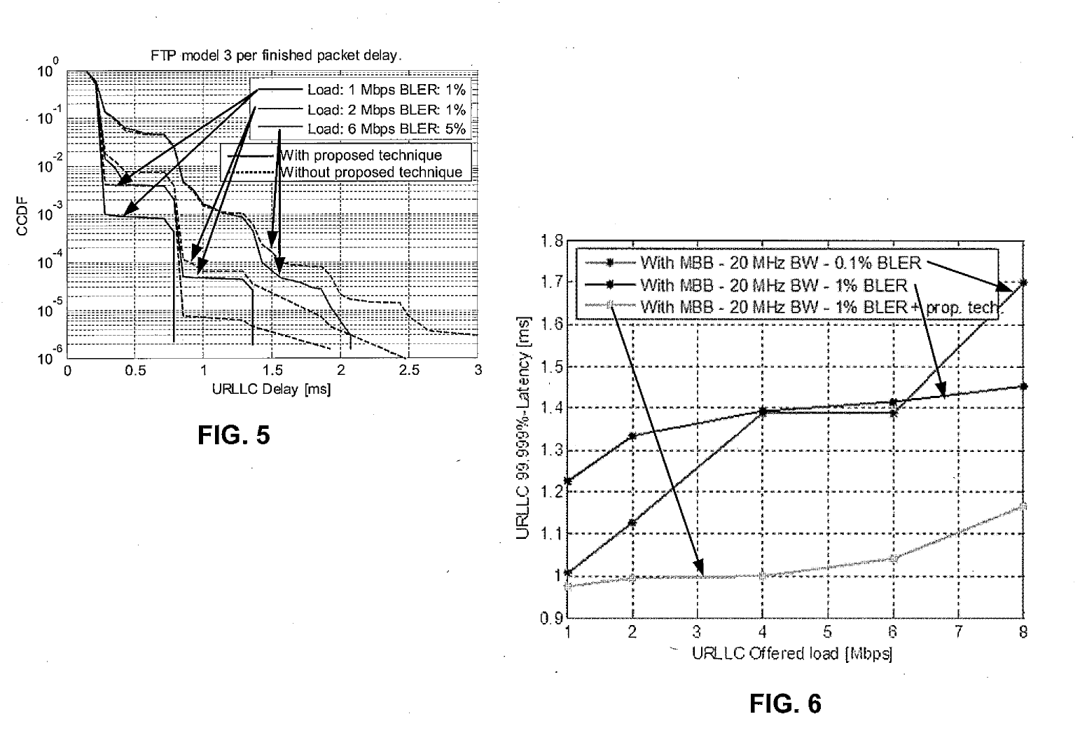

FIG. 5 shows the complementary cumulative distribution function (CCDF) of the latency per received FTP3 packet for different offered loads per cell, and with and without the proposed technique. Similar to the illustration in FIG. 3, we assume F=1 in step 2a, proportional allocation in step 2b, and random assignment in 2c. The BLER parameter in the legend indicates the BLER target when the allocation in step 1 is performed, but the final BLER (after step 2) is generally lower. For example, at 1 Mbps offered load, the first transmission BLER is reduced from ˜0.5% to ˜0.1%. The first transmission BLER reduction is smaller at higher loads, which is one of the properties of the proposed technique. Despite this, significant improvement is obtained in the 10⁻⁵ percentile. For example, a 0.5 ms latency reduction is experienced at 2 and 6 Mbps offered load.

In the second set of results, the 210 URLLC UEs are complemented with 105 MBB UEs (5 MBB UEs per cell in average) with full buffer downlink traffic. The carrier bandwidth is increased from 10 MHz to 20 MHz. URLLC transmissions are prioritized over MBB transmissions.

FIG. 6 summarizes the URLLC latency performance with three different scheduling and link adaptation configurations: traditional scheduling procedure with (i) 0.1% and (ii) 1% BLER target, and (ii) the proposed technique with 1% BLER target in the initial allocation. It is observed that (i) allows achievement of a very good latency performance at low load, but performs worst at high load due to the increase of the queuing delay. The configuration (ii) performs better at high load but the error rate is not sufficiently low to achieve the 1 ms URLLC latency target. Finally, (iii) allows achievement of a good balance between BLER and queuing delay, such that a latency close to 1 ms is achieved from low load to high load.

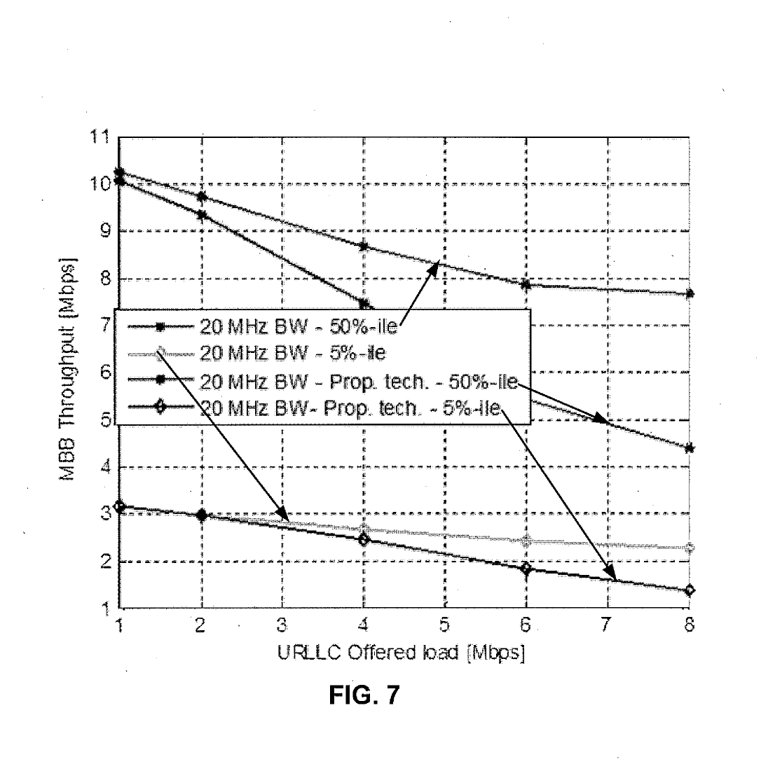

Next, FIG. 7 summarizes the MBB throughput performance with and without the proposed technique. At low load, URLLC consumes just a minority of the total resources, hence performing more conservative URLLC transmissions have little impact on the MBB throughput performance. At high load, the cost in terms of MBB throughput is much more visible: up to 40% degradation at the 50%-percentile (50%-ile) and 5%-percentile (5%-ile).

FIGS. 5-7 therefore illustrate some of the possible improvements that may be realized using various exemplary embodiments described herein.

Additional exemplary embodiments are as follows.

### Example 1

A method, comprising:

allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads;

reassigning at least one of remaining N−X PRBs to at least one user equipment that has already been allocated one or more PRBs;

adjusting the MCS to be used for the at least one user equipment given a total number of assigned PRBs per individual ones of the at least one user equipment, the adjusting lowering the initial error rate to a final error rate; and

transmitting the pending payloads to the one or more user equipment using the PRBs and the corresponding MCS.

### Example 2

The method of example 1, wherein reassigning at least one of remaining N−X PRBs to at least one user equipment that has already been allocated PRBs further comprises:

determining a proportion of the remaining N−X PRBs to assign to the at least one user equipment;

determining an amount of the remaining N−X PRBs to be assigned to each of the at least one user equipment such that all of the assigned amounts are less than or equal to the number of remaining N−X PRBs; and

choosing which assigned PRBs should be allocated to each of the at least one user equipment.

### Example 3

The method of example 2, wherein:

the at least one user equipment are multiple user equipment; and

the determining an amount of the remaining N−X PRBs to be assigned to each of the at least one user equipment further comprises increasing initial allocation for each of the multiple user equipment proportionally.

### Example 4

The method of example 3, wherein increasing initial allocation for each of the multiple user equipment proportionally is based on, for each selected one of the multiple user equipment, a proportion of PRBs already allocated for the selected user equipment to the X PRBs already allocated.

### Example 5

The method of example 4, wherein increasing initial allocation for each of the multiple user equipment proportionally further comprises applying a round function to each proportion for the multiple user equipment so that each of the multiple user equipment is assigned to an integer number of the remaining N−X PRBs.

### Example 6

The method of example 2, wherein the determining an amount of the remaining N−X PRBs to be assigned to each of the at least one user equipment further comprises allocating a larger proportion of PRBs based on a quality of service of a packet in a pending payload that is closer to a latency deadline.

### Example 7

The method of example 2, wherein the determining an amount of the remaining N−X PRBs to be assigned to each of the at least one user equipment further comprises prioritizing additional PRB allocations for a user equipment with a largest amount of pending data for transmission.

### Example 8

The method of any one of examples 2 to 7, wherein choosing which assigned PRBs should be allocated to each of the at least one user equipment further comprises choosing assignment of PRBs based on a random assignment of the assigned PRBs to each of the at least one user equipment.

### Example 9

The method of any one of examples 2 to 7, wherein choosing which assigned PRBs should be allocated to each of the at least one user equipment further comprises choosing assignment of PRBs based on channel quality information reports from the user equipment.

### Example 10

The method of example 9, wherein the pending payloads for the plurality of user equipment are determined to be higher priority and pending payloads for one or more additional user equipment are determined to be lower priority, and reassigning at least one of remaining N−X PRBs to at least one user equipment that has already been allocated one or more PRBs further comprises:

reassigning less than all of the remaining N−X PRBs to at least one user equipment that has already been allocated one or more PRBs; and

assigning unassigned PRBs to the one or more additional user equipment.

### Example 11

The method of example 10, wherein the user equipment that are determined to be higher priority are determined to be user equipment with low-latency and ultra-reliable communications requirements and corresponding traffic and the user equipment determined to be lower priority are mobile broad band or enhanced mobile broad band user equipment.

### Example 12

The method of any one of examples 1 to 10, wherein the user equipment assigned to at least one of remaining N−X PRBs are determined to be user equipment with low-latency and ultra-reliable communications requirements and corresponding traffic.

### Example 13

An apparatus, comprising:

at least one processor; and

at least one memory including computer program code,

the at least one memory and the computer program code configured, with the at least one processor, to cause the apparatus to perform operations comprising:

allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads;

reassigning at least one of remaining N−X PRBs to at least one user equipment that has already been allocated one or more PRBs;

adjusting the MCS to be used for the at least one user equipment given a total number of assigned PRBs per individual ones of the at least one user equipment, the adjusting lowering the initial error rate to a final error rate; and

transmitting the pending payloads to the one or more user equipment using the PRBs and the corresponding MCS.

### Example 14

The apparatus of example 13, wherein reassigning at least one of remaining N−X PRBs to at least one user equipment that has already been allocated PRBs further comprises:

determining a proportion of the remaining N−X PRBs to assign to the at least one user equipment;

determining an amount of the remaining N−X PRBs to be assigned to each of the at least one user equipment such that all of the assigned amounts are less than or equal to the number of remaining N−X PRBs; and

choosing which assigned PRBs should be allocated to each of the at least one user equipment.

### Example 15

The apparatus of example 14, wherein:

the at least one user equipment are multiple user equipment; and

the determining an amount of the remaining N−X PRBs to be assigned to each of the at least one user equipment further comprises increasing initial allocation for each of the multiple user equipment proportionally.

### Example 16

The apparatus of example 15, wherein increasing initial allocation for each of the multiple user equipment proportionally is based on, for each selected one of the multiple user equipment, a proportion of PRBs already allocated for the selected user equipment to the X PRBs already allocated.

### Example 17

The apparatus of example 16, wherein increasing initial allocation for each of the multiple user equipment proportionally further comprises applying a round function to each proportion for the multiple user equipment so that each of the multiple user equipment is assigned to an integer number of the remaining N−X PRBs.

### Example 18

The apparatus of example 14, wherein the determining an amount of the remaining N−X PRBs to be assigned to each of the at least one user equipment further comprises allocating a larger proportion of PRBs based on a quality of service of a packet in a pending payload that is closer to a latency deadline.

### Example 19

The apparatus of example 14, wherein the determining an amount of the remaining N−X PRBs to be assigned to each of the at least one user equipment further comprises prioritizing additional PRB allocations for a user equipment with a largest amount of pending data for transmission.

### Example 20

The apparatus of any one of examples 14 to 19, wherein choosing which assigned PRBs should be allocated to each of the at least one user equipment further comprises choosing assignment of PRBs based on a random assignment of the assigned PRBs to each of the at least one user equipment.

### Example 21

The apparatus of any one of examples 14 to 19, wherein choosing which assigned PRBs should be allocated to each of the at least one user equipment further comprises choosing assignment of PRBs based on channel quality information reports from the user equipment.

### Example 22

The apparatus of example 21, wherein the pending payloads for the plurality of user equipment are determined to be higher priority and pending payloads for one or more additional user equipment are determined to be lower priority, and reassigning at least one of remaining N−X PRBs to at least one user equipment that has already been allocated one or more PRBs further comprises:

reassigning less than all of the remaining N−X PRBs to at least one user equipment that has already been allocated one or more PRBs; and

assigning unassigned PRBs to the one or more additional user equipment.

### Example 23

The apparatus of example 22, wherein the user equipment that are determined to be higher priority are determined to be user equipment with low-latency and ultra-reliable communications requirements and corresponding traffic and the user equipment determined to be lower priority are mobile broad band or enhanced mobile broad band user equipment.

### Example 24

The apparatus of any one of examples 13 to 22, wherein the user equipment assigned to at least one of remaining N−X PRBs are determined to be user equipment with low-latency and ultra-reliable communications requirements and corresponding traffic.

### Example 25

A computer program product comprising a computer-readable storage medium bearing computer program code embodied therein for use with a computer, the computer program code comprising:

code for allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads;

code for reassigning at least one of remaining N−X PRBs to at least one user equipment that has already been allocated one or more PRBs;

code for adjusting the MCS to be used for the at least one user equipment given a total number of assigned PRBs per individual ones of the at least one user equipment, the adjusting lowering the initial error rate to a final error rate; and

code for transmitting the pending payloads to the one or more user equipment using the PRBs and the corresponding MCS.

### Example 26

The computer program product of example 25, further comprising code for performing any one of the methods of examples 1-12.

### Example 27

An additional exemplary embodiment includes a computer program, comprising code for performing the methods in any of the examples 1-12, when the computer program is run on a processor. Example 28. The computer program according to example 27, wherein the computer program is a computer program product comprising a computer-readable medium bearing computer program code embodied therein for use with a computer.

### Example 29

An apparatus comprising: means for allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads; means for reassigning at least one of remaining N−X PRBs to at least one user equipment that has already been allocated one or more PRBs; means for adjusting the MCS to be used for the at least one user equipment given a total number of assigned PRBs per individual ones of the at least one user equipment, the adjusting lowering the initial error rate to a final error rate; and means for transmitting the pending payloads to the one or more user equipment using the PRBs and the corresponding MCS.

### Example 30

The apparatus of example 29, further comprising means for performing the methods of any of claims 2-12.

### Example 31

A communication system comprising the apparatus of any of claims 13-24, 29, and 30.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

% percent

3GPP third generation partnership project

5G fifth generation

BLER block-error rate

BW bandwidth

CCDF cumulative distribution function

CQI channel quality indicator

eMBB enhanced MBB

eNB (or eNodeB) evolved Node B (e.g., an LTE base station)

gNB (or gNodeB) base station for 5G/NR

I/F interface

KPI key performance indicator

LA link adaptation

LTE long term evolution

Mbps megabits per second

MBB mobile broad band

MCS modulation and coding scheme

MHz megaHertz

MIMO multiple input, multiple output

MME mobility management entity

mMTC massive machine-type communications

ms millisecond

NCE network control element

NR new radio

N/W network

OFDM orthogonal frequency division multiplexing

PF proportional fair

PRB physical resource block

PS packet scheduling or packet scheduler

QoS quality of service

RRH remote radio head

Rx receiver

SGW serving gateway

TDD time division duplex

TR technical report

TTI transmission time interval

Tx transmitter

UE user equipment (e.g., a wireless, typically mobile device)

URLLC ultra-reliable low-latency communication

1. A method, comprising:
allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads;
reassigning at least one of remaining N−X PRBs to at least one user equipment that has already been allocated one or more PRBs;
adjusting the MCS to be used for the at least one user equipment given a total number of assigned PRBs per individual ones of the at least one user equipment, the adjusting lowering the initial error rate to a final error rate; and
transmitting the pending payloads to the one or more user equipment using the PRBs and the corresponding MCS.

2. The method of claim 1, wherein reassigning at least one of remaining N−X PRBs to at least one user equipment that has already been allocated PRBs further comprises:
determining a proportion of the remaining N−X PRBs to assign to the at least one user equipment;
determining an amount of the remaining N−X PRBs to be assigned to each of the at least one user equipment such that all of the assigned amounts are less than or equal to the number of remaining N−X PRBs; and
choosing which assigned PRBs should be allocated to each of the at least one user equipment.

3. (canceled)

4. (canceled)

5. (canceled)

6. The method of claim 2, wherein the determining an amount of the remaining N−X PRBs to be assigned to each of the at least one user equipment further comprises allocating a larger proportion of PRBs based on a quality of service of a packet in a pending payload that is closer to a latency deadline.

7. The method of claim 2, wherein the determining an amount of the remaining N−X PRBs to be assigned to each of the at least one user equipment further comprises prioritizing additional PRB allocations for a user equipment with a largest amount of pending data for transmission.

8. The method of claim 2, wherein choosing which assigned PRBs should be allocated to each of the at least one user equipment further comprises choosing assignment of PRBs based on a random assignment of the assigned PRBs to each of the at least one user equipment.

9. The method of claim 2, wherein choosing which assigned PRBs should be allocated to each of the at least one user equipment further comprises choosing assignment of PRBs based on channel quality information reports from the user equipment.

10. (canceled)

11. (canceled)

12. The method of claim 1, wherein the user equipment assigned to at least one of remaining N−X PRBs are determined to be user equipment with low-latency and ultra-reliable communications requirements and corresponding traffic.

13. An apparatus, comprising:
at least one processor; and
at least one memory including computer program code,
the at least one memory and the computer program code configured, with the at least one processor, to cause the apparatus to perform operations comprising:
allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads;
reassigning at least one of remaining N−X PRBs to at least one user equipment that has already been allocated one or more PRBs;
adjusting the MCS to be used for the at least one user equipment given a total number of assigned PRBs per individual ones of the at least one user equipment, the adjusting lowering the initial error rate to a final error rate; and
transmitting the pending payloads to the one or more user equipment using the PRBs and the corresponding MCS.

14. The apparatus of claim 13, wherein reassigning at least one of remaining N−X PRBs to at least one user equipment that has already been allocated PRBs further comprises:
determining a proportion of the remaining N−X PRBs to assign to the at least one user equipment;
determining an amount of the remaining N−X PRBs to be assigned to each of the at least one user equipment such that all of the assigned amounts are less than or equal to the number of remaining N−X PRBs; and
choosing which assigned PRBs should be allocated to each of the at least one user equipment.

15. The apparatus of claim 14, wherein:
the at least one user equipment are multiple user equipment; and
the determining an amount of the remaining N−X PRBs to be assigned to each of the at least one user equipment further comprises increasing initial allocation for each of the multiple user equipment proportionally.

16. The apparatus of claim 15, wherein increasing initial allocation for each of the multiple user equipment proportionally is based on, for each selected one of the multiple user equipment, a proportion of PRBs already allocated for the selected user equipment to the X PRBs already allocated.

17. The apparatus of claim 16, wherein increasing initial allocation for each of the multiple user equipment proportionally further comprises applying a round function to each proportion for the multiple user equipment so that each of the multiple user equipment is assigned to an integer number of the remaining N−X PRBs.

18. The apparatus of claim 14, wherein the determining an amount of the remaining N−X PRBs to be assigned to each of the at least one user equipment further comprises allocating a larger proportion of PRBs based on a quality of service of a packet in a pending payload that is closer to a latency deadline.

19. The apparatus of claim 14, wherein the determining an amount of the remaining N−X PRBs to be assigned to each of the at least one user equipment further comprises prioritizing additional PRB allocations for a user equipment with a largest amount of pending data for transmission.

20. The apparatus of claim 14, wherein choosing which assigned PRBs should be allocated to each of the at least one user equipment further comprises choosing assignment of PRBs based on a random assignment of the assigned PRBs to each of the at least one user equipment.

21. The apparatus of claim 14, wherein choosing which assigned PRBs should be allocated to each of the at least one user equipment further comprises choosing assignment of PRBs based on channel quality information reports from the user equipment.

22. The apparatus of claim 21, wherein the pending payloads for the plurality of user equipment are determined to be higher priority and pending payloads for one or more additional user equipment are determined to be lower priority, and reassigning at least one of remaining N−X PRBs to at least one user equipment that has already been allocated one or more PRBs further comprises:
reassigning less than all of the remaining N−X PRBs to at least one user equipment that has already been allocated one or more PRBs; and
assigning unassigned PRBs to the one or more additional user equipment.

23. The apparatus of claim 22, wherein the user equipment that are determined to be higher priority are determined to be user equipment with low-latency and ultra-reliable communications requirements and corresponding traffic and the user equipment determined to be lower priority are mobile broad band or enhanced mobile broad band user equipment.

24. The apparatus of claim 13, wherein the user equipment assigned to at least one of remaining N−X PRBs are determined to be user equipment with low-latency and ultra-reliable communications requirements and corresponding traffic.

25. A computer program product comprising a computer-readable storage medium bearing computer program code embodied therein for use with a computer, the computer program code comprising:
code for allocating one or more of a plurality of user equipment with a pending payload to individual sets of physical resource blocks (PRBs), the allocating assigning X of N total PRBs to be transmitted, X<N, wherein the allocating is performed to accommodate transmission of the corresponding payloads, given a required modulation and coding scheme (MCS) for each of the one or more user equipment, to meet an initial error rate for transmission of the payloads;
code for reassigning at least one of remaining N−X PRBs to at least one user equipment that has already been allocated one or more PRBs;
code for adjusting the MCS to be used for the at least one user equipment given a total number of assigned PRBs per individual ones of the at least one user equipment, the adjusting lowering the initial error rate to a final error rate; and
code for transmitting the pending payloads to the one or more user equipment using the PRBs and the corresponding MCS.
